(19) United States
(12) Patent Application Publication
(10) Pub. No.: US 2013/0151820 A1
(43) Pub. Date: Jun. 13, 2013

(54) METHOD AND APPARATUS FOR ROTATING AND SHIFTING DATA DURING AN EXECUTION PIPELINE CYCLE OF A PROCESSOR

(71) Applicants: Srikanth Arekapudi, Sunnyvale, CA (US); Saurabh Gupta, Meerut (IN)

(72) Inventors: Srikanth Arekapudi, Sunnyvale, CA (US); Saurabh Gupta, Meerut (IN)

(73) Assignee: Advanced Micro Devices, Inc., Sunnyvale, CA (US)

(21) Appl. No.: 13/315,380

(22) Filed: Dec. 9, 2011

(51) Int. Cl. G06F 9/302

(52) U.S. Cl. 712/221; 712/E09.017

(57) ABSTRACT

A method and apparatus are described for processing data during an execution pipeline cycle of a processor. Valid bits of the data are generated according to a designated data size. Each of the valid bits is inserted into at least one of a plurality of bit positions. The valid bits are rotated in a predetermined direction (i.e., left or right rotation) by a designated number of bit positions. Valid bits are removed from a portion of the plurality of bit positions after being rotated. Zeros or most significant bits (MSBs) of the data may be inserted in the bit positions from which the valid bits were removed. The number of bit positions to rotate the valid bits by may be designated by a first bit subset and a second bit subset. The first bit subset may indicate a number of bytes, and the second bit subset may indicate a number of bits.

### FIELD OF INVENTION

This application is related to the design of a processor.

### BACKGROUND

Dedicated pipeline queues have been used in multi-pipeline execution (EX) units of processors, (e.g., central processing units (CPUs), graphics processing units (GPUs), and the like), in order to achieve faster processing speeds. In particular, dedicated queues have been used in conjunction with EX units having multiple EX pipelines that are configured to execute different subsets of a set of supported micro-operations, (i.e., micro-instructions). Dedicated queuing has generated various bottlenecking problems and problems for the scheduling of micro-operations that required both numeric manipulation and retrieval/storage of data.

Additionally, processors are conventionally designed to process operations that are typically identified by operation (Op) codes (OpCodes), (i.e., instruction codes). In the design of new processors, it is important to be able to process all of a standard set of operations so that existing computer programs based on the standardized codes will operate without the need for translating operations into an entirely new code base. Processor designs may further incorporate the ability to process new operations, but backwards compatibility to older operation sets is often desirable.

Operations (Ops) represent the actual work to be performed. Operations represent the issuing of operands to implicit (such as add) or explicit (such as divide) functional units. Operations may be moved around by a scheduler queue.

Operands are the arguments to operations, (i.e., instructions). Operands may include expressions, registers or constants.

Execution of micro-operations (uOps) is typically performed in an EX unit of a processor core. To increase speed, multi-core processors have been developed. To facilitate faster execution throughput, “pipeline” execution of operations within an execution unit of a processor core is used. Cores having multiple execution units for multi-thread processing are also being developed. However, there is a continuing demand for faster throughput for processors.

One type of standardized set of operations is the operation set compatible with “x86” chips, (e.g., 8086, 286, 386, and the like), that have enjoyed widespread use in many personal computers. The micro-operation sets, such as the x86 operation set, include operations requiring numeric manipulation, operations requiring retrieval and/or storage of data, and operations that require both numeric manipulation and retrieval/storage of data. To execute such operations, execution units within processor cores have included two types of pipelines: arithmetic logic pipelines (“EX pipelines”) to execute numeric manipulations and address generation (AG) pipelines (“AG pipelines”) to facilitate load and store operations.

In order to quickly and efficiently process operations as required by a particular computer program, the program commands are decoded into operations within the supported set of micro-operations and dispatched to the EX unit for processing.

A shifter in the EX unit may perform several x86 instructions that require shifting or rotating the data in a register or data from memory, e.g., rotate left (ROL), rotate right (ROR), shift left (SHL), shift right (SHR), shift arithmetic right (SAR), and the like. These instructions may be 8-bit, 16-bit, 32-bit or 64-bit operations. A method and apparatus are needed to improve the latency of shift operation execution by shifting or rotating this data and generating results and flags within a single phase or half-cycle to meet high core frequency targets and limited silicon area.

### SUMMARY OF EMBODIMENTS

A method and apparatus are described for processing data during an execution pipeline cycle of a processor. Valid bits of the data are generated according to a designated data size. Each of the valid bits is inserted into at least one of a plurality of bit positions. The valid bits are rotated in a predetermined direction by a designated number of bit positions. Valid bits are removed from a portion of the plurality of bit positions after being rotated.

The number of removed valid bits may be equal to the designated number of bit positions by which the valid bits were rotated. Zeros or most significant bits (MSBs) of the data may be inserted in the bit positions from which the valid bits were removed. The predetermined direction may be a left rotation or a right rotation.

The number of bit positions to rotate the valid bits by may be designated by a first bit subset and a second bit subset. The first bit subset may indicate a number of bytes, and the second bit subset may indicate a number of bits.

The plurality of bit positions may include bit positions 00 through 63, and the designated data size may be 8 bits, 16 bits, 32 bits or 64 bits.

The processor may includes a first multiplexer, a rotator array and a second multiplexer. The first multiplexer may be configured to receive data and generate valid bits of the data according to a designated data size. The rotator array may be configured to insert the valid bits into at least one of a plurality of bit positions and rotate the valid bits in a predetermined direction by a designated number of bit positions. The second multiplexer may be configured to remove valid bits from a portion of the plurality of bit positions after being rotated by the rotator array.

A computer-readable storage medium may be configured to store a set of instructions used for manufacturing a semiconductor device. The semiconductor device may comprises a first multiplexer configured to receive data and generate valid bits of the data according to a designated data size, a rotator array configured to insert the valid bits into at least one of a plurality of bit positions and rotate the valid bits in a predetermined direction by a designated number of bit positions, and a second multiplexer configured to remove valid bits from a portion of the plurality of bit positions after being rotated by the rotator array. The instructions may be Verilog data instructions or hardware description language (HDL) instructions.

### BRIEF DESCRIPTION OF THE DRAWINGS

A more detailed understanding may be had from the following description, given by way of example in conjunction with the accompanying drawings wherein:

FIG. 1 shows an example of an execution (EX) pipeline cycle of a processor performing a multi-cycle operation;

FIG. 2 shows an example block diagram of the processor used to perform the EX pipeline cycle of FIG. 1;

FIG. 3 shows an example block diagram of a rotator/shifter;

FIG. 4 shows an example of inserting valid bits output by an input multiplexer (MUX) in the rotator/shifter of FIG. 3 into a predetermined number of bit positions;

FIGS. 5A and 5B show examples of shift operations performed by the rotator/shifter of FIG. 3;

FIG. 6 is a flow diagram of a procedure for processing data during an execution pipeline cycle of a processor;

FIG. 7A is a block diagram of an example device in which one or more disclosed embodiments may be implemented; and

FIG. 7B is a block diagram of an alternate example device in which one or more disclosed embodiments may be implemented.

### DETAILED DESCRIPTION OF EMBODIMENTS

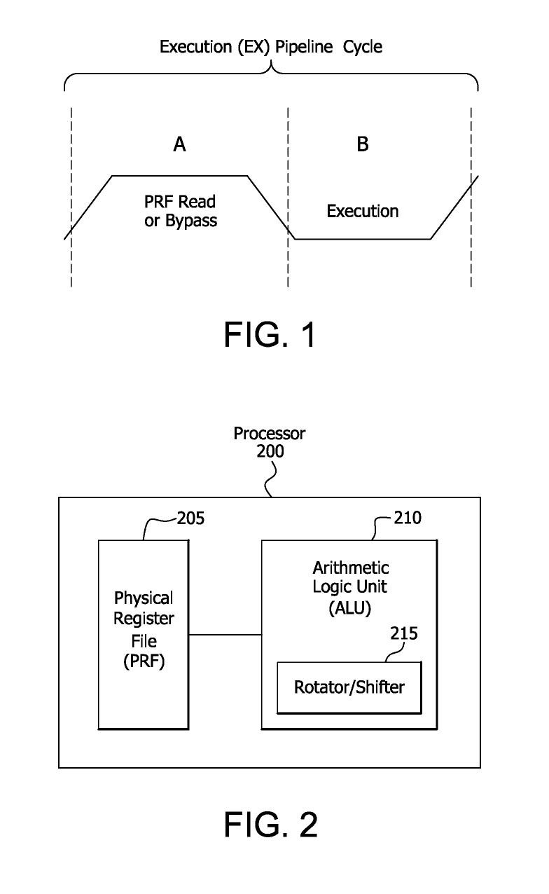

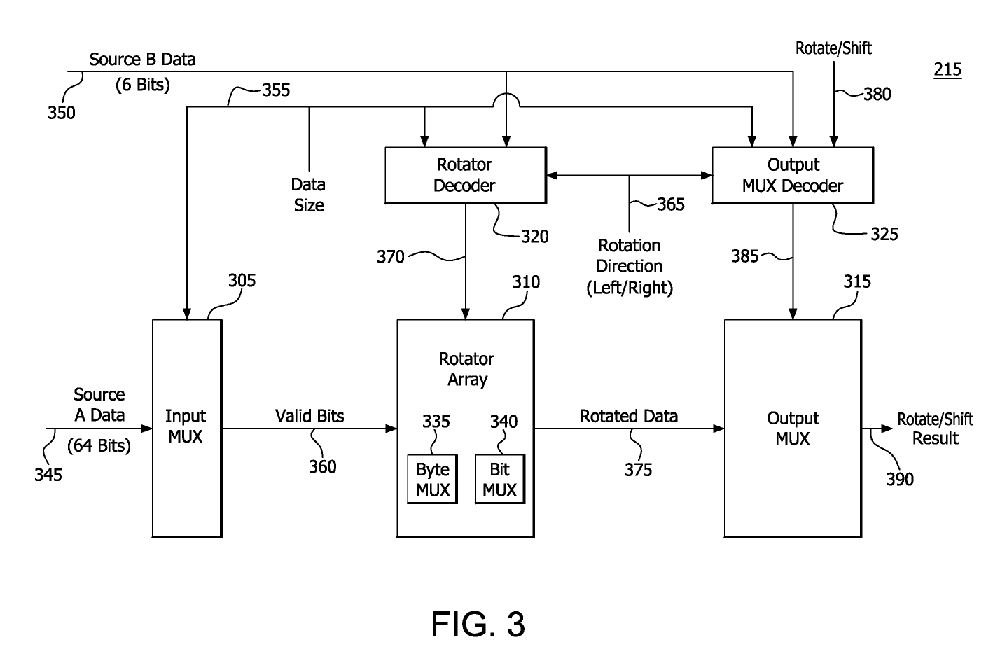

FIG. 1 shows an example of an EX pipeline cycle of a processor performing a multi-cycle operation. FIG. 2 shows an example block diagram of a processor 200 configured to perform the multi-cycle operation of FIG. 1. The processor 200 may include a physical register file (PRF) and an arithmetic logic unit (ALU) 210 including a rotator/shifter 215. In phase A of the EX pipeline cycle, a PRF read or bypass operation may be performed, whereby data associated with a uOp may be read from the PRF 205. In phase B of the EX pipeline cycle, execution may be implemented by the rotator/shifter 215 in the ALU 210 to execute the data read from the PRF.

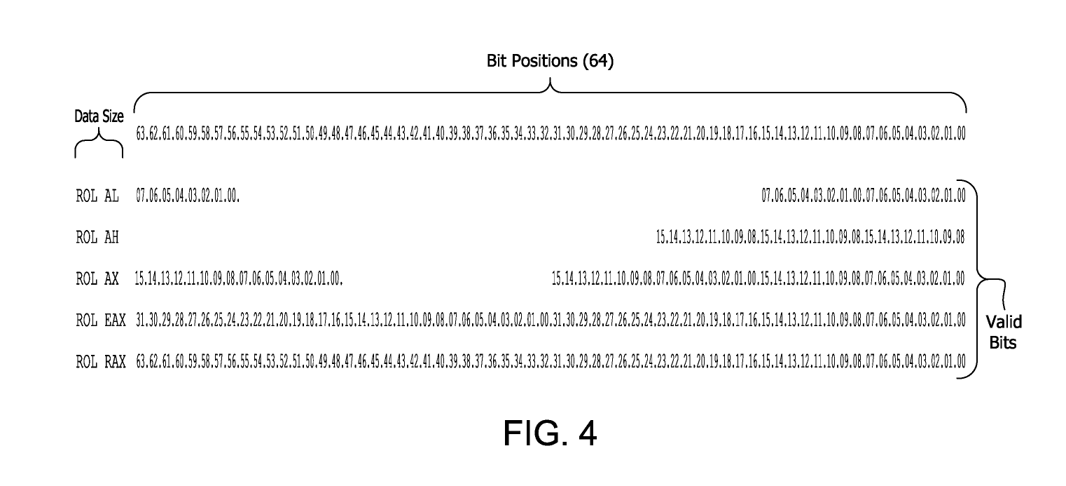

FIG. 3 shows an example block diagram of the rotator/shifter 215 in the ALU 210 of the processor 200 shown in FIG. 2. The rotator/shifter 215 may be configured to process data received from two different sources “A” and B″. The rotator/shifter 215 may include an input multiplexer (MUX) 305, a rotator array 310, an output MUX 315, a rotator decoder 320, an output MUX decoder 325 and a flag generator 330. The rotator array 310 may include a byte MUX 335 and a bit MUX 340. Source A data 345 is input to the input MUX 305 for rotation and shifting by the rotator/shifter 215. Source B data 350 is input into the rotator decoder 320 and the output MUX decoder 325 to control the amount of rotation and shifting.

In an example used throughout the following description of operation of the rotator/shifter 215, the source A data 345 may include 64 bits, of which a portion, (e.g., 8 bits, 16 bits or 32 bits), or all of the bits, (e.g., 64 bits), may be valid. The number of valid bits may be designated by a data size instruction 355 that is input to the input MUX 305 and the rotator array 310, whereby an “AL” data size represents a “low byte” data size indicating that 8 bits (07 through 00) are valid and bits 63 through 08 are invalid; an “AH” data size represents a “high byte” data size indicating that 8 bits (15 through 08) are valid and bits 63 through 16, and 07 through 00, are invalid; an “AX” data size represents a data size indicating 16 bits (15 through 00) are valid and bits 63 through 16 are invalid; an “EAX” data size represents a data size indicating 32 bits (31 through 00) are valid and bits 63 through 32 are invalid; and an “RAX” data size represents a data size indicating that all of the 64 bits (63 through 00) are valid. Thus, the input MUX 305 may be configured to arrange (i.e., manipulate) the source A data 345 and output valid bits 360 to the rotator array 310 for rotation.

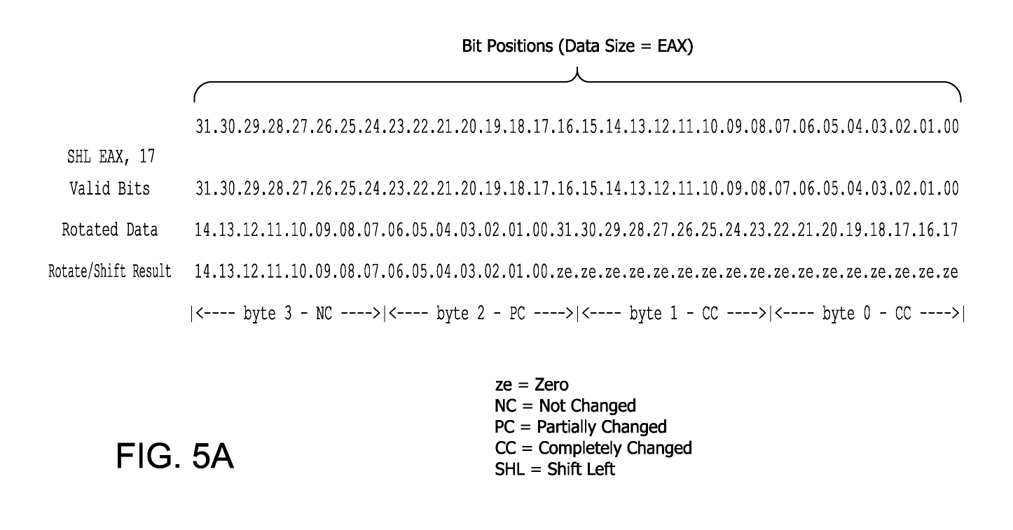

FIG. 4 shows an example of inserting each of the valid bits 360 output by the input MUX 305 into at least one of a predetermined number (e.g., 64) bit positions. In this example, a rotate left (ROL) scenario for each data size, (AL, AH, AX, EAX and RAX), is illustrated by FIG. 4. For an AL or AH data size, (i.e., 8 valid bits), it is not necessary to replicate the valid data 8 times, since any shift greater than 8 may be represented with a shift amount below 8. For example, a shift amount of 9, 17, 25, 33, 41, 49 or 57 for an AL data size will generate the same rotated data as for a shift amount of 1. Thus, the replication of valid data for various data sizes by the input MUX 305 may be reduced, which saves silicon logic area.

The source B data 350, for example, may include six bits including a first set of bits “XXX” and a second set of bits “YYY” that, together as “XXXYYY”, indicate the number of bit positions by which the rotator array 310 may rotate the valid bits 360. The first set of bits (“XXX”) may indicate to the byte MUX 335 of the rotator array 310 how many bytes to rotate by, and the second set of bits (“YYY”) may indicate to the bit MUX 340 of the rotator array 310 how many bits to rotate by. The byte MUX 335 and the bit MUX 340 may, for example, be an 8:1 MUX having 8 select inputs and 1 output, thus each requiring an 8 bit input where only one of the 8 select inputs is a logic 1 (i.e., “one hot”).

For example, if the source B data 350 is “001001”, the rotator decoder 320 may convert this data into formatted data 370 required by the byte MUX 335 and the bit MUX 340 in the rotator array 310, (e.g., two separate 8 bit signals for each of the byte MUX 335 and the bit MUX 340), such that the rotator array 310 rotates the valid bits 350 by 9 bits, (i.e., (XXX=001=1 byte=8 bits)+(YYY=001=1 bit)). In another example, if the source B data 350 is “010 001”, the rotator decoder 320 may convert this data into a formatted data 370 required by the byte MUX 335 and the bit MUX 340 in the rotator array 310 such that the rotator array 310 rotates the valid bits 360 by 17 bits, (i.e., (XXX=010=2 bytes=16 bits)+(YYY=001=1 bit)).

In addition, since the rotator array 310 may be configured to only perform left rotation (ROL) or right rotation (ROR), the rotator decoder 320 may configured to convert the source B data 350 based on rotation direction data 365 such that the source B data 350 is applicable to the rotation direction used by the rotator array 310. For example, if the rotator array 310 rotates data to the left, the rotator decoder 320 may convert ROR formatted data, as indicated by the rotation direction data 365, to an ROL format. For an “RAX” data size (64 bits), a right rotation of 47 bits (XXXYYY=101111) may be converted to a left rotation of 17 bits by the rotator decoder 320 calculating the 2's complement of the 47 bits, where (101111)₂=010000+1=010001=17. Alternatively, if the rotator array 310 only rotates data to the right, the rotator decoder 320 may convert ROL formatted data, as indicated by the rotation direction data 365, to an ROR format in a similar manner.

The output MUX 315 receives rotated data 375 from the rotator array 310. The output MUX decoder 325 receives the source B data 350, rotation direction data 365 and rotate/shift data 380, and outputs shift select data 385 required by the output MUX 315 to mask some of the bits of the rotated data 375 by a predetermined number of bit positions (e.g., 17 bit positions) for the shift operations. The output MUX 315 replaces the bits that are shifted out by either zeros, in the case of an SHL (identical to shift arithmetic left (SAL)) or SHR operation, or by the most significant bit (MSB) of the source A data 345 in the case of an SAR operation. The shift select data 385 may be used by the output MUX 315 to select between the rotated data 375 and preselected zeros/MSBs to generate a rotate/shift result 390, depending on the operation.

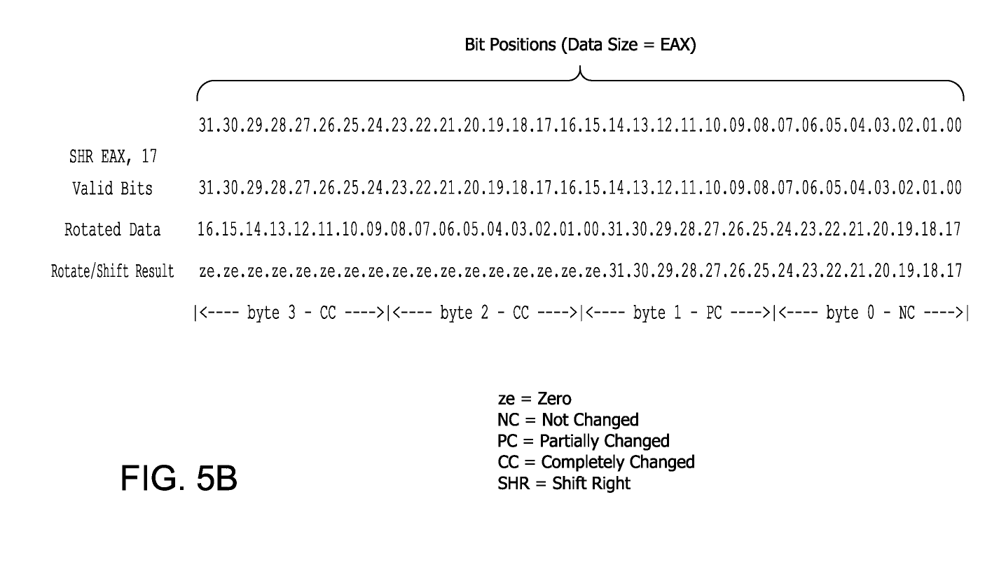

FIG. 5A shows an example of the outputs of the input MUX 305, the rotator array 310 and the output MUX 315 of the rotator/shifter 215 of FIG. 3 for a shift left (SHL) of 17 bits where bytes 0 and 1 are complete changed (CC), byte 2 is partially changed (PC), and the actual amount is decoded, and bytes 2 and 3 are not changed (NC) and are the same as the rotated data 375.

FIG. 5B shows an example of the outputs of the input MUX 305, the rotator array 310 and the output MUX 315 of the rotator/shifter 215 of FIG. 3 for a shift right (SHR) of 17 bits where byte 0 is not changed (NC) and is the same as the rotated data 375, byte 1 is partially changed (PC), and the actual amount is decoded, and bytes 2 and 3 are completely changed (CC).

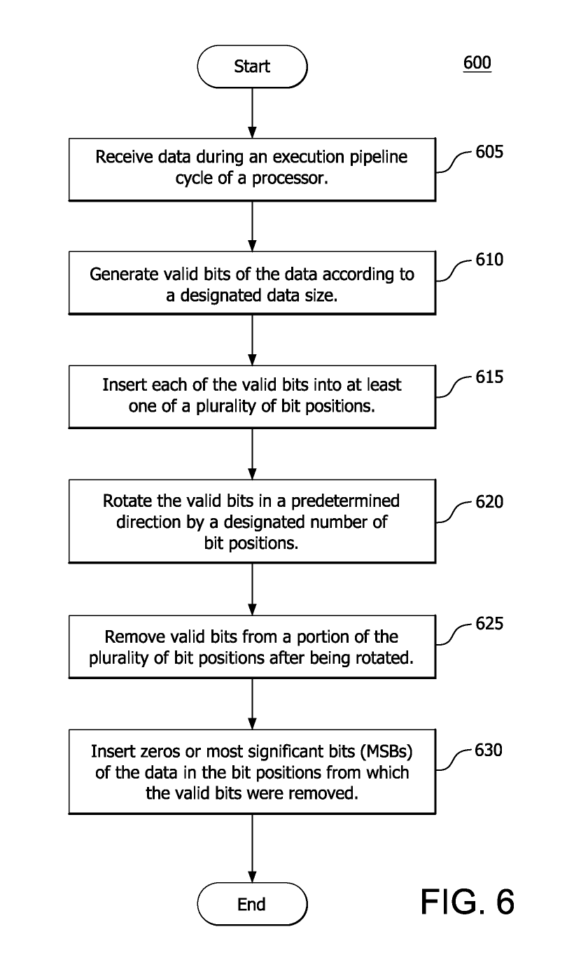

FIG. 6 is a flow diagram of a procedure 600 for processing data during an execution pipeline cycle of a processor. Data is received during an EX pipeline cycle of a processor (605). Valid bits of the data are generated according to a designated data size (610). Each of the valid bits is inserted into at least one of a plurality of bit positions (615). The valid bits are rotated in a predetermined direction by a designated number of bit positions (620). Valid bits are removed from a portion of the plurality of bit positions after being rotated (625). Zeros or most significant bits (MSBs) of the data are inserted in the bit positions from which the valid bits were removed (630).

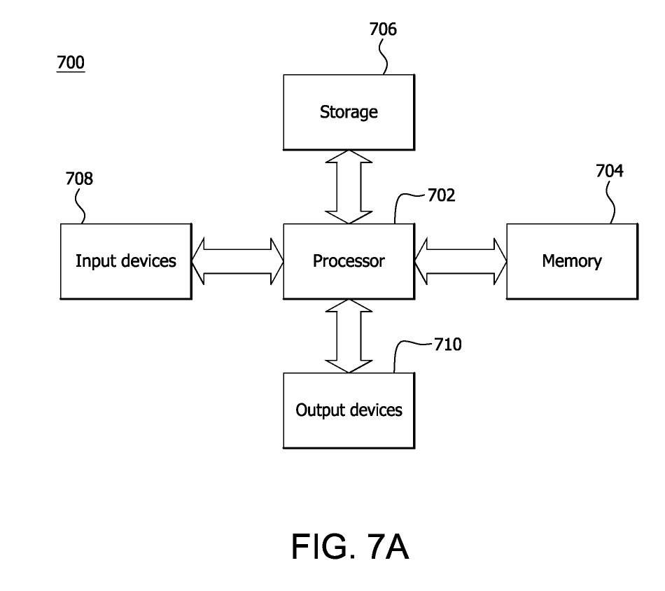

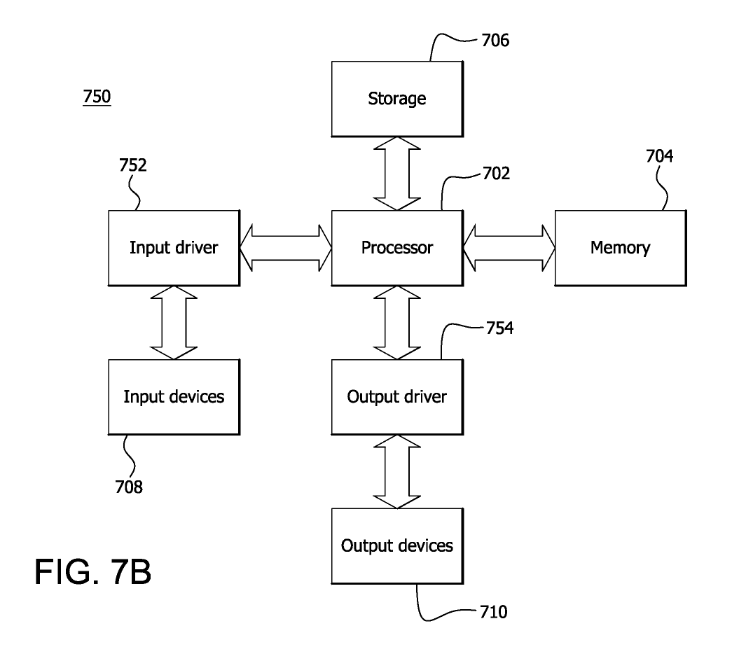

FIG. 7A is a block diagram of an example device 700 in which one or more disclosed embodiments may be implemented. The device 700 may include, for example, a computer, a gaming device, a handheld device, a set-top box, a television, a mobile phone, or a tablet computer. The device 700 includes a processor 702 having a similar configuration as the processor 200 of FIG. 2, a memory 704, a storage 706, one or more input devices 708, and one or more output devices 710. It is understood that the device 700 may include additional components not shown in FIG. 7A.

The processor 702 may include a central processing unit (CPU), a graphics processing unit (GPU), a CPU and GPU located on the same die, one or more processor cores, wherein each processor core may be a CPU or a GPU. The memory 704 may be located on the same die as the processor 702, or may be located separately from the processor 704. The memory 704 may include a volatile or non-volatile memory, for example, random access memory (RAM), dynamic RAM, or a cache.

The storage 706 may include a fixed or removable storage, for example, hard disk drive, solid state drive, optical disk, or flash drive. The input devices 708 may include a keyboard, a keypad, a touch screen, a touch pad, a detector, a microphone, an accelerometer, a gyroscope, a biometric scanner, or a network connection, (e.g., a wireless local area network card for transmission and/or reception of wireless IEEE 802 signals). The output devices 710 may include a display, a speaker, a printer, a haptic feedback device, one or more lights, an antenna, or a network connection, (e.g., a wireless local area network card for transmission and/or reception of wireless IEEE 802 signals).

FIG. 7B is a block diagram of an alternate example device 750 in which one or more disclosed embodiments may be implemented. Elements of the device 750 which are the same as in the device 700 are given like reference numbers. In addition to the processor 702, the memory 704, the storage 706, the input devices 708, and the output devices 710, the device 750 also includes an input driver 752 and an output driver 754.

The input driver 752 communicates with the processor 702 and the input devices 708, and permits the processor 702 to receive input from the input devices 708. The output driver 754 communicates with the processor 702 and the output devices 710, and permits the processor 702 to send output to the output devices 710.

Although features and elements are described above in particular combinations, each feature or element can be used alone without the other features and elements or in various combinations with or without other features and elements. The apparatus described herein may be manufactured by using a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), an accelerated processing unit (APU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A method of processing data during an execution pipeline cycle of a processor, the method comprising:
generating valid bits of the data according to a designated data size;
inserting each of the valid bits into at least one of a plurality of bit positions;
rotating the valid bits in a predetermined direction by a designated number of bit positions; and
removing valid bits from a portion of the plurality of bit positions after being rotated.

2. The method of claim 1 wherein the number of removed valid bits is equal to the designated number of bit positions that the valid bits were rotated by.

3. The method of claim 1 further comprising:
inserting zeros or most significant bits (MSBs) of the data in the bit positions from which the valid bits were removed.

4. The method of claim 3 wherein the execution pipeline cycle includes a first phase during which data in a physical register file (PRF) is read, and a second phase during which the data read from the PRF is processed to generate results and flags before the second phase ends.

5. The method of claim 1 wherein the predetermined direction is a left rotation.

6. The method of claim 1 wherein the predetermined direction is a right rotation.

7. The method of claim 1 wherein the number of bit positions to rotate the valid bits by is designated by a first bit subset and a second bit subset, wherein the first bit subset indicates a number of bytes, and the second bit subset indicates a number of bits.

8. The method of claim 1 wherein the plurality of bit positions include bit positions 00 through 63.

9. The method of claim 1 wherein the designated data size is 8 bits.

10. The method of claim 1 wherein the designated data size is 16 bits.

11. The method of claim 1 wherein the designated data size is 32 bits.

12. The method of claim 1 wherein the designated data size is 64 bits.

13. A processor for processing data during an execution pipeline cycle, the processor comprising:
a first multiplexer configured to receive data and generate valid bits of the data according to a designated data size;
a rotator array configured to insert the valid bits into at least one of a plurality of bit positions and rotate the valid bits in a predetermined direction by a designated number of bit positions; and
a second multiplexer configured to remove valid bits from a portion of the plurality of bit positions after being rotated by the rotator array.

14. The processor of claim 13 wherein the number of removed valid bits is equal to the designated number of bit positions that the valid bits were rotated by.

15. The processor of claim 13 wherein the second multiplexer is further configured to insert zeros or most significant bits (MSBs) of the data in the bit positions from which the valid bits were removed.

16. The processor of claim 13 wherein the predetermined direction is a left rotation.

17. The processor of claim 13 wherein the predetermined direction is a right rotation.

18. The processor of claim 13 wherein the number of bit positions to rotate the valid bits by is designated by a first bit subset and a second bit subset, wherein the first bit subset indicates a number of bytes, and the second bit subset indicates a number of bits.

19. A computer-readable storage medium configured to store a set of instructions used for manufacturing a semiconductor device, wherein the semiconductor device comprises:
a first multiplexer configured to receive data and generate valid bits of the data according to a designated data size;
a rotator array configured to insert the valid bits into at least one of a plurality of bit positions and rotate the valid bits in a predetermined direction by a designated number of bit positions; and
a second multiplexer configured to remove valid bits from a portion of the plurality of bit positions after being rotated by the rotator array.

20. The computer-readable storage medium of claim 19 wherein the instructions are Verilog data instructions.

21. The computer-readable storage medium of claim 19 wherein the instructions are hardware description language (HDL) instructions.

22. A computer-readable storage medium configured to store data processed during an execution pipeline cycle by generating valid bits of the data according to a designated data size, inserting each of the valid bits into at least one of a plurality of bit positions, rotating the valid bits in a predetermined direction by a designated number of bit positions, and removing valid bits from a portion of the plurality of bit positions after being rotated.
